(19) United States
(12) Patent Application Publication
(10) Pub. No.: US 2014/0304549 A1
(43) Pub. Date: Oct. 9, 2014

(54) RECOVERING A FAILURE IN A DATA PROCESSING SYSTEM

(71) Applicant: HEWLETT-PACKARD DEVELOPMENT COMPANY, L.P., Houston, TX (US)

(72) Inventors: Meichun Hsu, Los Altos, CA (US); Qiming Chen, Cupertino, CA (US); Maria G. Castellanos, Sunnyvale, CA (US)

(73) Assignee: HEWLETT-PACKARD DEVELOPMENT COMPANY, L.P., Houston, TX (US)

(21) Appl. No.: 13/857,716

(22) Filed: Apr. 5, 2013

(51) Int. Cl. G06F 11/07

(52) U.S. Cl. CPC G06F 11/0793
USPC 714/15

(57) ABSTRACT

A technique of recovering a failure in a data processing system comprises recording a number of input channels and sequence numbers for a number of input tuples transferred to a recipient task, recording a number of output channels and sequence numbers for a number of output tuples, and if a failure occurs, resolving the input and output channels.

### BACKGROUND

Real-time stream analytics has increasingly gained popularity among entities such as corporations in order to capture and update business information just-in-time, analyze continuously generated moving data from sensors, mobile devices, and social media of all types, and gain live business intelligence. In some of these instances, the stream analytics may be implemented in a cloud service. Thus, there exists an increasing demand for reliability and fault-tolerance in these types of cloud services by both entities that provide and entities that use such cloud services. In stream analytics processing, parallel and distributed tasks are chained in a graph-structure. The streaming tuples are processed in the order of their generation on each dataflow path, and each task is processed once and only once. To enforce streaming oriented transaction properly, a task's execution state of processing each tuple is checkpointed. If the task fails and is recovered, an associated data processing device restores the latest state and resends a missing tuple.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIG. 1 is a diagram of a data processing system for keeping track of dataflow channels and resolving message channels in the event of a failure, according to one example of the principles described herein.

FIG. 2 is a diagram of a logical streaming process with operations, links, and dataflow grouping types, according to one example of the principles described herein.

FIG. 3 is a diagram of a physical streaming process with each operation of FIG. 2 having multiple instances, according to one example of the principles described herein.

FIG. 4 is a flowchart showing task execution utilizing backtrack-based checkpoint and recovery data processing, according to one example of the principles described herein.

FIG. 5 is a flowchart showing task recovery, according to one example of the principles described herein.

FIG. 6 is a diagram depicting a system comprising a secondary messaging channel for ACK/ASK operations and resending of tuples, according to one example of the principles described herein.

FIG. 7 is a diagram depicting a grouping example, according to one example of the principles described herein.

FIG. 8 is diagram depicting reasoning of output channels using TOC for the grouping example of FIG. 7.

FIG. 9 is a diagram of an experimental result of the physical streaming process with each operation having multiple instances of FIG. 3, according to one example of the principles described herein.

FIG. 10 is a diagram depicting a latency ratio with and without checkpoint, according to one example of the principles described herein.

FIG. 11 is a diagram depicting a performance comparison between ACK based and ASK based recovery protocols, according to one example of the principles described herein.

FIG. 12 is a flowchart showing recovery of a failure in a data processing system, according to one example of the principles described herein.

Throughout the drawings, identical reference numbers designate similar, but not necessarily identical, elements.

### DETAILED DESCRIPTION

One transactional streaming approach treats the whole process as a single task, and therefore suffers from the loss of intermediate results when a failure occurs. Another transactional streaming approach is characterized by waiting for acknowledgement (ACK) before moving forward, on the per-tuple basis. In one example under this second approach, a task keeps resending the current output, but does not move on to processing the next input until the current output is processed and acknowledged by all target tasks. Both of these approaches incur extremely high latency penalties in processing data.

Supporting fault tolerance in distributed systems using messaging logging and checkpointing assumes that each pair of sender and receiver tasks know the physical messaging channel between them, and a system facility is provided for re-sorting the messages in the message queues. However, in component based distributed infrastructures, the data routing between operations is handled by separate system components; and there is not a message re-sorting component accessible to the tasks. This creates a paradox in building a transaction layer on-top of an existing stream processing platform since implementing either an ACK based or ASK based mechanism means the physical input/output channels are kept track by the tasks. However, this is not the case.

The present systems and methods track the physical input/output logically. The notions of virtual channel, task alias and messageId-set are described herein. Further, the present systems and methods provide for reasoning, storing, and communicating of channel information to define the physical input/output channels of the various tasks. The present systems and methods also provide a designated messaging channel, separated from a regular dataflow channel, for signaling ACK/ASK messages and resending tuples, and for avoiding the interruption of the regular order of tuple delivery. All these transactional properties are system supported and transparent to users. The present ASK based backtrack methods significantly outperform an ACK based mechanism.

According to an example, a method of recovering a failure in a data processing system includes recording a number of input channels and sequence numbers for a number of input tuples transferred via a first messaging channel to a recipient task. The method further includes recording a number of output channels and sequence numbers for a number of output tuples, and if a failure occurs, resolving the input and output channels.

As used in the present specification and in the appended claims, the term “stream” is meant to be understood broadly as an unbounded sequence of tuples. A streaming process is constructed with graph-structurally chained streaming operations.

As used in the present specification and in the appended claims, the term “task” is meant to be understood broadly as a process or execution instance supported by an operating system. In one example, a task processes a number of input tuples one by one, sequentially. An operation may have multiple parallel and distributed tasks which may reside on different machine nodes. A task runs cycle by cycle continuously for transforming a stream into a new stream where in each cycle the task processes an input tuple, sends the resulting tuple or tuples to a number of target tasks, and, in some examples, acknowledges the source task where the input came from upon the completion of the computation.

Further, as used in the present specification and in the appended claims, the term “checkpoint” or similar language is meant to be understood broadly as any identifier or other reference that identifies the state of the task at a point in time.

Even still further, as used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

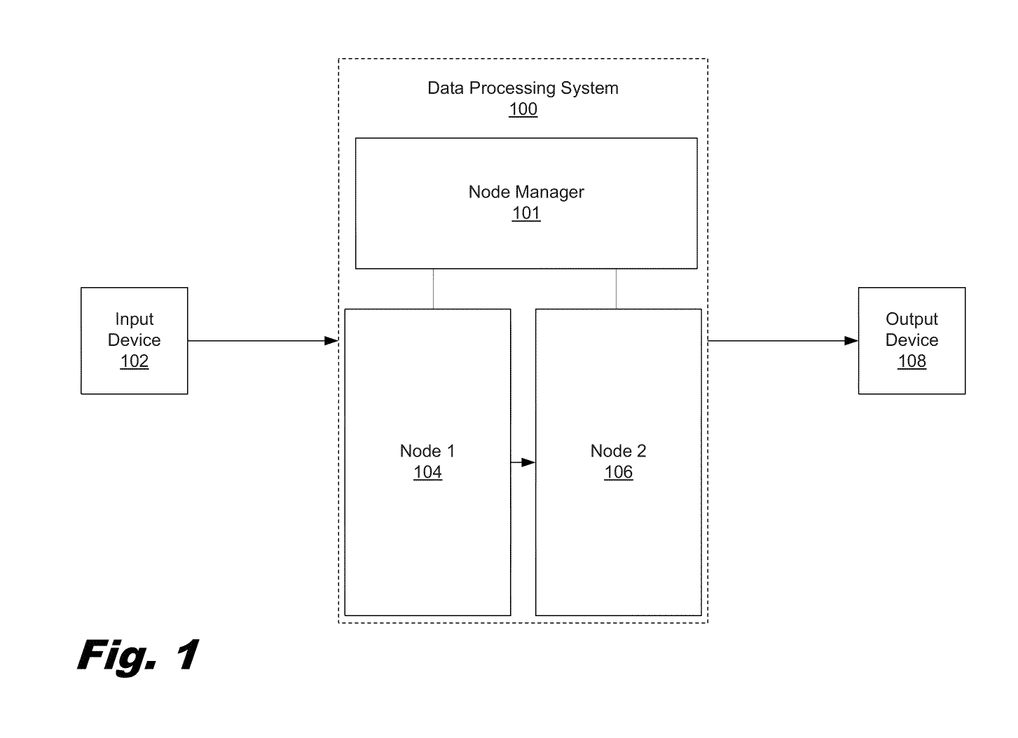

Turning now to the figures, FIG. 1 is a diagram of a data processing system (100) for keeping track of dataflow channels and resolving message channels in the event of a failure, according to one example of the principles described herein. The data processing system (100) accepts input from an input device (102), which may comprise data, such as records. The data processing system (100) may be a distributed processing system, a parallel processing system, or combinations thereof. In the example of a distributed system, multiple autonomous processing nodes (104, 106), comprising a number of data processing devices, may communicate through a computer network and operate cooperatively to perform a task. Though a parallel processing computing system can based on a single computer, in a parallel processing system as described herein, a number of processing devices cooperatively and substantially simultaneously perform a task. There are architectures of parallel processing systems where a number of processors are geographically near-by and may share resources such as memory. However, processors in those systems also work cooperatively and substantially simultaneously on task performance.

A node manager (101) to manage data flow through the number of nodes (104, 106) comprises a number of data processing devices and a memory. The data node manager (101) executes the checkpointing of messages sent among the nodes (104, 106) within the data processing system (100), the recovery of failed tasks within or among the nodes (104, 106), and other methods and processes described herein.

Input (102) coming to the data processing system (100) may be either bounded data, such as data sets from databases, or stream data. The data processing system (100) and node manager (101) may process and analyze incoming records from input (102) using, for example, structured query language (SQL) queries to collect information and create an output (108).

Within data processing system (100) are a number of processing nodes (104, 106). Although only two processing nodes (104, 106) are shown in FIG. 1, any number of processing nodes may be utilized within the data processing system (100). In one example, the data processing system (100) may comprise a large number of nodes such as, for example, hundreds of nodes operating in parallel and/or performing distributed processing.

Node 1 (104) may comprise any type of processing stored in a memory of node 1 (104) to process a number of records and number of tuples before sending the tuples for further processing at node 2 (106). In this manner, any number of nodes (104, 106) and their associated tasks or sub-tasks may be chained where the output of a number of tasks or sub-tasks may be the input of a number of subsequent tasks or sub-tasks.

The data processing system (100) may be utilized in any data processing scenario including, for example, a cloud computing service such as a Software as a Service (SaaS), a Platform as a Service (PaaS), a Infrastructure as a Service (IaaS), application program interface (API) as a service (APIaaS), other forms of network services, or combinations thereof. Further, the data processing system (100) may be used in a public cloud network, a private cloud network, a hybrid cloud network, other forms of networks, or combinations thereof. In one example, the methods provided by the data processing system (100) are provided as a service over a network by, for example, a third party. In another example, the methods provided by the data processing system (100) are executed by a local administrator.

As described above, the data processing system (100) utilizes backtrack-based checkpoint and recovery to resend missing tuples only when a task recovered from a failure, asynchronously execute ASK relative to task execution, garbage-collect the buffered output tuples after they are successfully processed by the target tasks, keep track of input/output dataflow channels before that task communicates to its target or source tasks, and resolve message channels in the event of a failure, among other processes. In one example, the present data processing system (100) may be built on top of an existing distributed stream processing infrastructure such as, for example, STORM, a cross platform complex event processor and distributed computation framework developed by Backtype and owned by Twitter, Inc. STORM is a system supported by and transparent to users. The present ASK based backtrack methods significantly outperform an ACK based mechanism. Thus, the present system is a real-time, continuous, parallel, and elastic stream analytics platform built on top of STORM.

In one example, there are two kinds of nodes within a cluster: a “coordinator node” and a number of “agent nodes” with each running a corresponding daemon. In one example, the node manager (101) is the coordinator node, and the agent nodes are nodes 1 and 2 (104, 106). A dataflow process is handled by the coordinator node and the agent nodes spread across multiple machine nodes. The coordinator node (101) is responsible for distributing code around the cluster, assigning tasks to machines, and monitoring for failures, in the way similar to APACHE HADOOP software framework developed and distributed by Apache Software Foundation. Each agent node (104, 106) interacts with the coordinator node (101) and executes some operator instances as threads of the dataflow process. In one example, the present system platform may be built using several open-source tools, including, for example, APACHE ZOOKEEPER distributed application process coordinator developed and distributed by Apache Software Foundation, ØMQ asynchronous messaging library developed and distributed by iMatix Corporation, KRYO object graph serialization framework, and STORM, among other tools. ZOOKEEPER coordinates distributed applications on multiple nodes elastically. ØMQ supports efficient and reliable messaging, KRYO deals with object serialization, and STORM provides the basic dataflow topology support. To support elastic parallelism, the present systems and methods allow a logical operator to execute by multiple physical instances, as threads, in parallel across the cluster, and the nodes (104, 106) pass messages to each other in a distributed manner. Using the ØMQ library, message delivery is reliable, messages never pass through any sort of central router, and there are no intermediate queues.

Stream analytics as a cloud service supports many applications. This has given rise to a focus on the reliability and fault-tolerance of distributed stream processing. In a graph-structured streaming process with distributed tasks, the goal of transactional streaming is to ensure the streaming records, referred to as tuples, are processed in the order of their generation in each dataflow path, with each tuple processed once and only once. Since transactional streaming deals with chained tasks, computation results as well as the dataflow between cascading tasks is taken into account. The present approach is based on a persisting data processing state for recovery, and resending of missing tuples to a task after it is recovered from a failure.

The present systems and methods provide for reasoning about physical messaging channels logically by allowing a transactionally guarded task to process tuples continuously without waiting for ACKs and without resending in the normal case. The source tasks are requested to resend the missing tuple only when the task is recovered from a failure. This may be referred to as backtrack based, or ASK based recovery protocol as indicated above, and is distinguished from an ACK based recovery mechanism. With the present backtrack based approach, ACK is asynchronous to task execution, and is utilized for “garbage-collecting” the buffered output tuples after they are successfully processed by the target tasks. Since failures are rare, to backtrack the missing tuple would not have significant impact on the overall efficiency of data stream processing.

In implementing the present backtrack recovery protocol on top of an existing stream processing infrastructure, the input/output dataflow channels are kept track of by a given task before that task communicates to its target or source tasks. However, in component based distributed systems, routing data is handled by the system components separate from the tasks, which leads to a kind of paradox. In a distributed dataflow infrastructure, messages passed between tasks are not handled by tasks themselves but by the distributed routing facilities with the knowledge about the system topology and configuration. For example, in a Map-Reduce platform, passing Map results to Reduce tasks is handled by the Map-Reduce platform, and not by the Map tasks because the Reduce tasks are unknown to the Map tasks. In a parallel, distributed, and elastic streaming process, each logical “operation” can be multiple execution instances or “tasks.” Given a source operation and a target operation with each having multiple task instances, the target tasks may subscribe the output streams of the source tasks in different ways. Specifically, the target tasks may subscribe the output streams of the source tasks through use of different grouping criteria such as shuffle-grouping with load-balance oriented random selection, fields-grouping with hash partitioning, all-grouping by delivering to all, among others.

When an operation O has multiple target operations, the output of a task of O is delivered to multiple sets of target tasks with different grouping criteria. When a source task emits one tuple, that tuple may be routed to a number of recipient tasks, but where exactly it goes may be uncertain to the sender task. This may be referred to as an “output channel paradox.” A recipient task also has multiple source tasks, and if and when the recipient task fails and is restored, it is unknown where the possible missing tuple came from. This may be referred to as an “input channel paradox.”

The purpose of the present systems and methods is to build a reliable streaming transaction layer on top of a parallel and distributed stream processing infrastructure such as, for example, STORM that addresses the above-described message channel resolution in the event of a failure. Thus, rather than re-develop a new system, the present systems and methods will not change the underlying routing facilities but focus on tracking the physical dataflow channel logically by reasoning.

Under the present approach, a dataflow channel is identified by a “source-task-id” and “target-task-id.” Each tuple is identified by a “message-id,” or “mid,” comprising a channel and a seq# to identify the sequence number of tuples that passed via that channel. The input and output channels may be extracted from the topology of the stream process initially by a task, but the input/output mids are tracked during continuous execution. To get rid of the above-described logical paradox, the notions of “virtual channel,” “task alias,” and “mid-set” are used in reasoning, tracking, and communicating the channel information.

Based on these concepts the streaming transaction properties are automatically supported by the present system and are transparent to users so that no user code is required. Further, the present systems and methods provide a “designated messaging channel” that is separated from the regular dataflow channel, for signaling ACK/ASK and resending tuples, and for avoiding the interruption of the regular order of tuple delivery. The present ASK based backtrack protocol significantly outperforms the ACK based protocol.

As to graph-structured distributed streaming processes, real-time stream analytics has increasingly gained popularity among entities such as corporations in order to capture and update business information just-in-time, analyze continuously generated moving data from sensors, mobile devices, and social media of all types, and gain live business intelligence as mentioned above. The present systems and methods deal with continuous, real-time dataflow with graph-structured topology. This platform is massively parallel, distributed, and elastic with each logical operator executed by multiple physical instances running in parallel over distributed server nodes. The stream analysis operators can be defined flexibly by users.

A stream is an unbounded sequence of tuples. A streaming process is constructed with graph-structurally chained streaming operations. An operation may have multiple parallel and distributed execution instances called tasks which may reside on different machine nodes. A task runs cycle by cycle continuously, and transforms a stream into a new stream where, in each cycle, it processes an input tuple, acknowledges the source task (i.e., where the input comes from) upon the completion of the computation, and sends the resulting tuples to its target tasks.

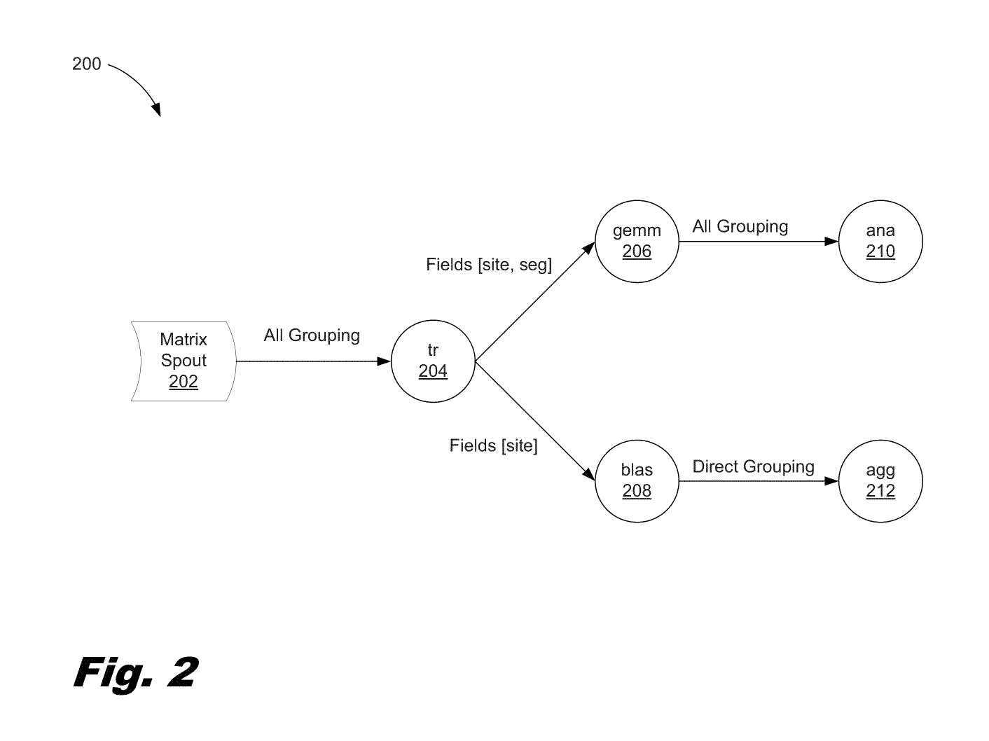

The present infrastructure is built by extending a parallel and distributed stream processing infrastructure such as, for example, the above-mentioned STORM. FIG. 2 is an example of a logical streaming process. Specifically, FIG. 2 is a diagram of a logical streaming process (200) with operations, links, and dataflow grouping types, according to one example of the principles described herein. In this streaming process example for matrix data manipulation, the source tuples are streamed out from a “matrix spout” (202) with each tuple comprising three equal-sized float matrices generated randomly in size and content. The tuples first flow to a transformation operation, “tr” (204), and then to a general matrix multiplication operation, “gemm” (206) and a basic linear algebra operation, “blas” (208), with fields-grouping on different hash keys. The output of the gemm operation (206) is delivered to an analysis operation, “ana” (210) with all-grouping, and of “blas” to an aggregation operation, “agg” (212) with direct-grouping. The partial specification of the graph structure, or topology, of this streaming process is listed as follows:

TopologyBuilder builder = new TopologyBuilder( );
builder.setSpout(″matrix_spout″, matrix_spout, 1);
builder.setBolt(“tr”, tr, 2).allGrouping(″matrix_spout″);
builder.setBolt(″gemm″, gemm, 2).fieldsGrouping(“tr”, new

Fields(″site″, ″seg″));

builder.setBolt(″ana″, ana, 2).allGrouping(″gemm″);
builder.setBolt(″blas″, blas, 2).fieldsGrouping(“tr”, new

Fields(″site″));

builder.setBolt(″agg″, agg, 2).directGrouping(″blas″);

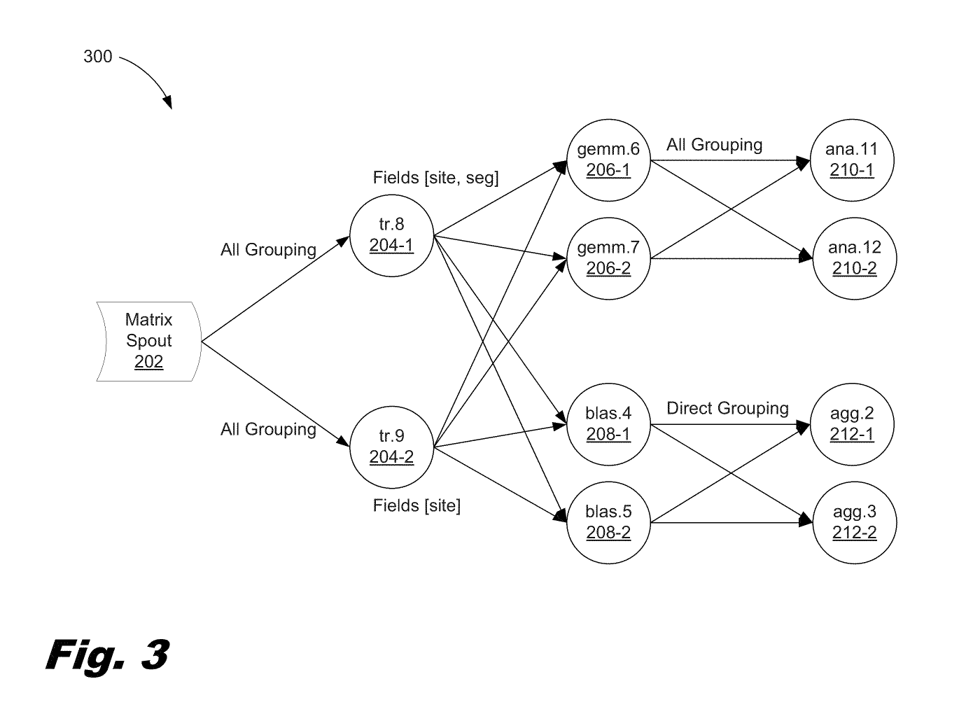

Physically, each operation has more than one task instance, and the tuples sent from the source tasks to the target tasks are grouped with various criteria. FIG. 3 is a diagram of a physical streaming process with each operation of FIG. 2 having multiple instances, according to one example of the principles described herein.

To identify the dataflow components of the present systems and methods, the following notations are introduced. First, a task number, “task#,” is assigned by the topology. Each task can be uniquely identified by its task#. Second, a task identification, “taskId,” is the task# preceded by an operation identification, “operationId,” for that task instance, and is denoted as “operationId.task#. For example, “taskId “agg.2” is a task of an operation named “agg.”

A “channel” is identified by the source and target taskIds, and is denoted as “srcTaskId̂targetTaskId.”; For example, a message channel from task tr.8 (204-1) to gemm.6 (206-1) is expressed as “tr.8̂gemm.6.” A message identification, “messageId,” or “mid,” is identified by the channel and the message sequence number via this channel and is denoted by “channel-seq#,” or more exactly by “srcTaskId̂targetTaskId-seq#.” For example, “tr.8̂gemm.6-134” identifies the 134th tuple sent via the channel from “tr.8” (204-1) to “gemm.6” (206-1).

Under the present transactional approach, a task runs continuously for processing input tuple by tuple. The tuples transmitted via a dataflow channel are sequenced and identified by the seq#, and guaranteed to be processed in order. A received tuple, t, with seq# earlier than the expected will be ignored. A received tuple, t, with seq# later than the expected will trigger the resend of the missing tuples to be processed before t. In this way, a tuple is processed once and only once, and in the restrict order. Further, the state and data processing results on each tuple are checkpointed for failure recovery.

For efficiency, a task does not rely on “ACK” to move forward. Instead, acknowledging is asynchronous to task execution, and is only used to remove the already emitted tuples not needed for resending any more. Since an ACK triggers the removal of the acknowledged tuple and all the tuples prior to that tuple, the ACK is allowed to be lost and not resent.

A task is a continuous execution instance of an operation hosted by a station where two major methods are provided. One method is the prepare( ) method that runs initially before processing input tuples for instantiating the system support (static state) and the initial data state (dynamic state). Another method is execute( ) for processing an input tuple in the main stream processing loop. Failure recovery is handled in prepare( ) since after a failed task restored it will experience the prepare( ) phase first.

With regard to task execution, a task runs cycle by cycle continuously for processing input tuple by tuple. The tuples transmitted via a dataflow channel are sequenced and identified by the seq#, and guaranteed to be processed in order A received tuple, t, with seq# earlier than the expected will be ignored, and a received tuple, t, with seq# later than the expected will trigger the resending of the missing tuples to be processed before t. This ensures each tuple to be processed once and only once and in the right order. Further, the state and data processing results on each tuple are checkpointed (serialized and persisted to file) for failure recovery. After checkpointing the transaction is committed, acknowledged, and then the results are emitted.

For efficiency, a task does not rely on the receipt of “ACK” to move forward. Instead, acknowledging is asynchronous to task execution and used to remove the buffered tuples already processed by the target tasks. Since an ACK triggers the removal of the acknowledged tuple and all the tuple prior to that tuple, the ACK is allowed to be lost.

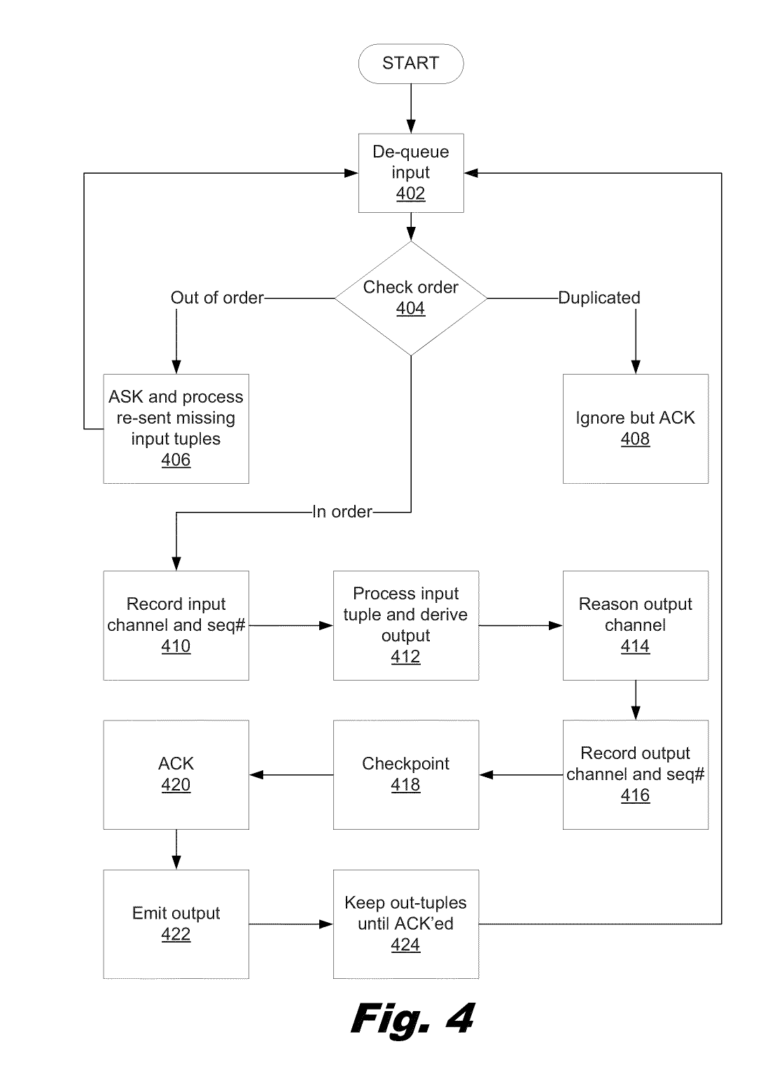

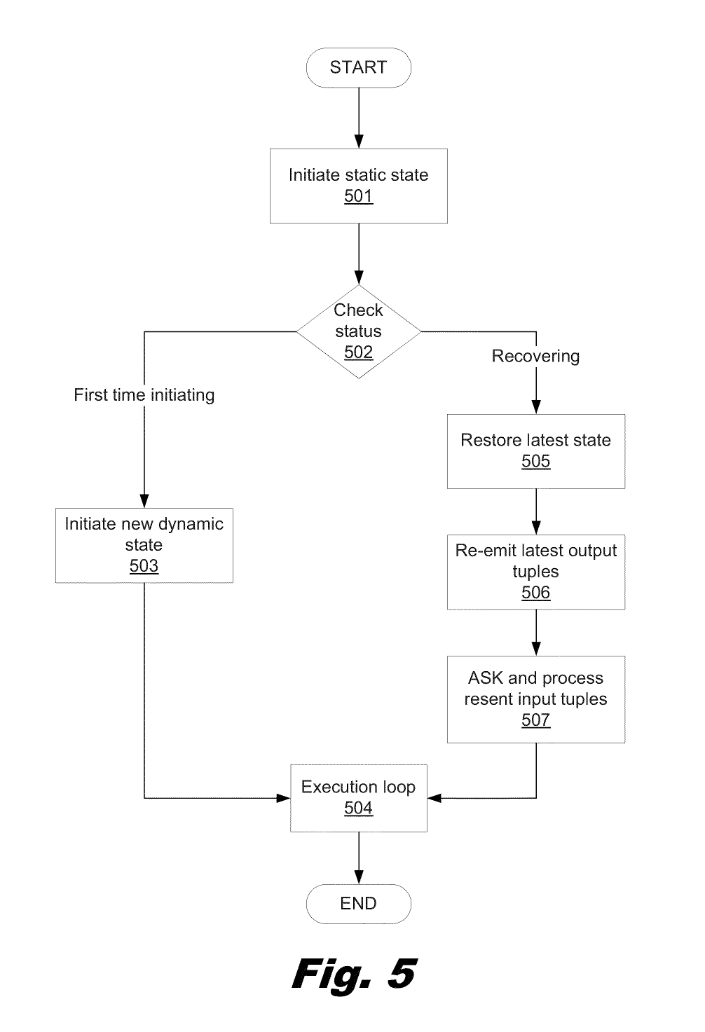

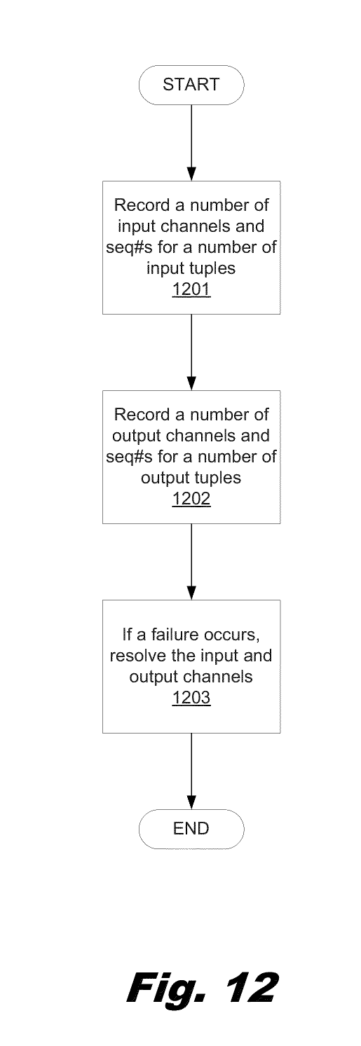

FIG. 12 is a flowchart showing recovery of a failure in a data processing system, according to one example of the principles described herein. The method of FIG. 12 may begin by the system (100) recording (block 1201) a number of input channels and sequence numbers for a number of input tuples transferred via a first messaging channel to a recipient task. The system (100) records (block 1202) a number of output channels and sequence numbers for a number of output tuples. If a failure occurs, the system (100) resolves (block 1203) the input and output channels. The method of FIG. 12 will be described in more detail in connection with FIGS. 4 and 5, as well as the remainder of the present disclosure.

Execute( ) is depicted in FIG. 4. FIG. 4 is a flowchart showing task execution utilizing backtrack-based checkpoint and recovery data processing, according to one example of the principles described herein. The method may begin by de-queuing (block 402) a number of input tuples. The seq# of each input tuple, t, is checked (block 404) as to order of the tuple. If t is a duplicate indicating the tuple has a smaller seq# than expected (block 404, determination “Duplicated”), it will not be processed again and ignored, but will be acknowledged (block 408) to allow the sender to remove t and the ones earlier than t. If t is instead “jumped” indicating the tuple has a seq# larger than expected (block 404, determination “out of order”), the missing tuples between the expected one and t will be requested, resent, and processed (block 406) first before moving to t. The method then returns to block 402 for the next input tuple.

If t is in order (block 404, determination “in order”), then the node manager (101) records input channels and seq#s (block 410). The input tuples are processed and the output tuples are derived (block 412). The output channels are “reasoned” (block 414) for checkpointing them to be used in a possible failure-recovery scenario, and the node manager (101) records output channels and seq#s (block 416) as part of the checkpointed state.

The node manager (101) checkpoints (block 418) the state and results, which comprise a list of objects. When a tuple is checked-in, the list is serialized into a byte-array to write to a binary file as a ByteArrayOutputStream, and when the tuple is checked-out, the byte-array obtained from reading the ByteArrayInputStream file is de-serialized to the list of objects representing the state.

After checkpointing, the transaction is committed, acknowledged (block (420), and the results are emitted (422). Thus, in the method of FIG. 4, the input/output channels and seq#s are recorded before checkpointing and emitting. Since each output tuple is emitted only once but possibly distributed to multiple destinations unknown to the task before emitting, the output channels are “reasoned” at block 414 for checkpointing them to be used in the possible failure-recovery. The node manager (101) retains the output tuples until an ACK message is received indicating that the tuples have been successfully processed by the target tasks. This is the “garbage collecting” described above.

Turning now to task recovery, the data processing system (100) may encounter a failed task instance re-initiated on an available machine node. This is performed by loading the serialized operation class to the selected node, and creating a new instance at that node. This process is supported by the underlying streaming platform. Since transactional streaming deals with chained tasks, the computation results as well as the messages for transferring the computation results between cascading tasks are taken into account. Once a task fails, the recovery of the task includes the recovery of its computation results, the recovery of its backward chaining for resolving any possible missing input, and the recovery of its forward chaining for redelivering its output if necessary.

Because a failure may cause the loss of input and output tuples, and since it is uncertain to the recovered task, those tuples are re-sent via the right physical channel as recorded and stored in the method of FIG. 4. FIG. 5 is a flowchart showing task recovery, according to one example of the principles described herein. Since a recovered task with multiple source tasks cannot determine where the missing task came from, the node manager (101) asks each source task to resend the possible next tuple with regard to the latest tuple received by the target task. Thus, a pair of source and target tasks that have a protocol on identifying the “latest tuple” are used. This is why the system (100) reasons and records each physical dataflow channel and keeps the input/output seq#. The method associated with prepare( ) is illustrated in FIG. 5. The method may begin by initiating (block 501) a static state. The status of a task is then checked (block 502) to determine if the system (100) is initiating for the first time or in a recovery process brought on by a failure in the task. If the system (100) determines that the status is a first time initiation (block 502, determination “first time initiating”), then the system initiates a new dynamic state (block 503), and processing moves to the execution loop (block 504) as described above in connection with FIG. 4.

If, however, the system (100) determines that the status is a recovery status (block 502, determination “recovering”), then the system rolls back to the last window state by restoring (block 505) a latest state and re-emitting (block 506) the latest output tuples (block 506). The system (100) sends (block 606) an ASK request and processes resent input tuples. Processing moves to the execution loop (block 504) as described above in connection with FIG. 4.

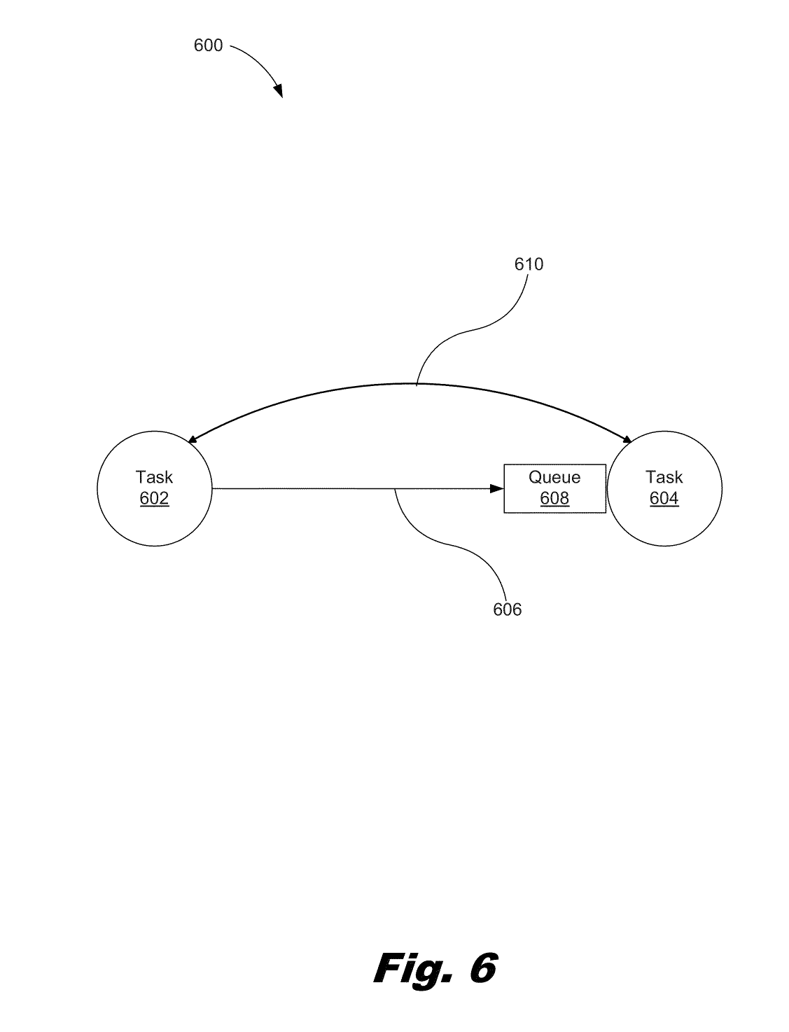

Another challenge in dealing with backtrack recovery is how to ensure the order of regular tuple delivery not interrupted by the task recovery process. Another challenge in such backward recovery is how to maintain the order of the input tuples. This is because the recovered task may receive multiple resent tuples, and, besides the resent tuple really missing, the other tuples, if not duplicated, may have been queued but not yet taken by the task. In this case, appending the resent tuple to the queue would lead to the mis-order of all the queued tuples. In other words, appending the resent tuples to the queue would interrupt the order of the queued tuples. The present system and methods solve this architecturally by providing for a task a second messaging channel. This second messaging channel is separated from the regular dataflow channel, and is used for signaling ACK/ASK and resending tuples. This second messaging channel (610) is depicted in FIG. 6. FIG. 6 is a diagram depicting a system (600) comprising a secondary messaging channel (610) for ACK/ASK operations and resending of tuples, according to one example of the principles described herein. When a task T (604) is restored from a failure, it first requests and processes the resent tuples from all input channels (602) before going to the normal execution loop. In this way, if a resent tuple has been put in the input queue (608) of T (604) previously, but not yet taken by T (604), that tuple can be identified as a duplicate tuple and ignored in the normal execution loop. Thus, resent tuples from all input channels are treated as a block operation by task T (604) initially after its recovery and before going to the normal execution loop.

In order to ensure the order of processing of input tuples during recovery, a specific messaging channel (610) for signaling ACK/ASK and for resent tuples is provisioned as a second messaging channel with respect to the regular messaging channel (606). In one example, every task (602, 604) is facilitated with a mini-messaging system, a distinguishing socket address (SA), and an address-book of its source and target tasks. The SA is carried with its output tuples for the recipient task to ACK/ASK through this second messaging channel (610). Due to the change of SA when a task is restored from a failure such as, for example, in the case where the task may be launched to another machine node, and due to the unavailability of the SA when it is first contacted, a Home Locator Registry (HLR) service is provided.

In order to request and resend a missing tuple during recovery, the recovered task (604), as the recipient of the missing tuple, and the source task (602), as the sender, having matching seq#s of the missing tuple. This means that the sender (602) records the seq# before emitting; a paradox since the sender (602) does not know the exact destination before emitting and given that the touting is responsible by the underlying infrastructure.

As mentioned above, the information about input/output channels and seq#s is represented by the MessageId, or mid, composed as srcTaskId̂targetTaskId-seq#, such as “tr.8̂gemm.6-134”. The mid “tr. 8̂gemm.6-134” identifies the 134th tuple sent from task “tr.8” to task “gemm.6”. However, tracking matched mid does not comprise recording and finding equal mids on the sender side and the recipient side since this is impossible when the grouping criteria are enforced by another system component. However, the recorded mid is logically consistent with the one actually emitted, and the recording is done before emitting. This is because under the present approach, the source task does not wait for ACK in rolling forward, and ACKs are allowed to be lost.

Thus, a task is to comply with the peer tasks on the mid of the tuple when re-emitting an output tuple or requesting/resending a missing input tuple during recovery. When a task, T₁ (602), sends a tuple to task, T₂ (604), through the messaging channel between them, T₁ (602) records the seq# via that channel before emitting the tuple, and T₂ (604) records the seq# upon receipt. This can be done if the message routing is responsible by the underlying infrastructure and the sender may or may not know the exact destination before emitting.

The above situation is the motivation for tracking messaging channels logically. The present systems and methods provide for the sender task (602) to express and record a mid in such a logical form that allows the recipient task (604) to recognize the matched logical channel and physical channel. This allows the sender task (602) to find the right tuple and resend it to the right recipient task (604) based on the “logical message identifier” when handling acknowledgements and in responding to re-send requests.

For guiding channel resolution, the present systems and methods extract from the streaming process definitions task specific meta-data, including the potential input and output channels as well as the grouping types. Each task is also recorded and kept updated, as a part of its checkpoint state, the message seq# in every input and output channel. Thus, a message identification set, “mid-set,” is used to identify the channels to all destinations of an emitted tuple. A mid-set is recorded with the source task and included in the output tuple. Each recipient task picks up the matched mid to record the corresponding seq#. Mid-sets only appear in and are recorded for output tuples. On the recipient side, the mid-set of a tuple is replaced by the matched mid to be used in both ACK and ASK. A logged tuple matches a mid in the ACK or ASK message can be simply found based on the set-membership relationship.

Further, “task alias” and “virtual mid” are used to resolve the destination of message sending with “fields-grouping,” or hash partitioning. In this case, the destination task is identified by a unique number yield from the hash and modulo functions as its alias. These parameters are described in more detail below with regard to the various grouping types.

Two kinds of “logical message identifiers,” are considered here. One logical message identifier is related to a set of recipients, and another is related to a virtual recipient. When an emitted tuple is delivered to multiple recipients through multiple message channels, the tuple to be identified by a mid-set is allowed. A mid-set contains multiple individual mids with the same source task but with different target tasks. On each recipient side, the target task picks up from that mid-set the mid with target taskId matching itself, and records the input channel and seq# accordingly. The matched mid will be used for identifying both ACK and ASK messages. In the other words, mid-sets only appear in the sender task, and are recorded for output tuples. In the recipient side, only the matched single mid is recorded and used. On the sender side, to find the kept tuple that matches the mid carried by an ACK or ASK message is achieved based on the set-membership relationship. As mentioned above, the tuple that matches an ACK message will be garbage-collected, and the tuple that matches an ASK message will be resent during failure recovery. A resent tuple is identified by a single, matched mid.

As mentioned above, “task alias” and “virtual mid” are used to resolve the destination of message sending with “fields-grouping” or hash partitioning. In this case, an output tuple only goes to one instance task of the given target operation which is determined by the routing component and is based on a unique number yield from the hash and modulo functions. Although the sender task has no knowledge about the physical destination before emitting a tuple, it can calculate that number, and can treat that number as the “alias” of the corresponding target task ID. The sender task can then create a “virtual mid” using that alias. A virtual mid is directly recorded and used in both the source task that sends the tuple, and the target task that receives the tuple. The use of “task alias” and “virtual mid” to resolve the messaging channels with regard to the various grouping types will now be described in more detail as follows.

With “all-grouping,” a task of the source operation sends each output tuple to multiple recipient tasks of the target operation. Since there is only one emitted tuple but multiple physical output channels, a message ID set, “MessageId Set,” or “mid-set” is used to identify the sent tuple. For example, a tuple sent from gemm.6 to ana.11 and ana.12 is identified by {gemm.6̂ana.11-96, gemm.6̂ana.12-96}. On the sender site (i.e., gemm.6), this mid-set is recorded and checkpointed. On the recipient site in each recipient task (i.e., ana.11), only the single mid matching the recipient task (i.e., gemm.6̂ana.11-96) will be extracted, recorded, and used in ACK and in ASK messages. In the sender task (i.e., gemm.6), the match of the ACK or ASK message identified by a single mid and the recorded tuple identified by a mid-set is determined by set membership. For example, the ACK or ASK message with mid gemm.6̂ana.11-96 or gemm.6̂ana.12-96 matches the tuple identified by {gemm.6̂ana.11-96, gemm.6̂ana.12-96}.

With “fields-grouping,” the tuples output from the source task are hash-partitioned to multiple target tasks, with one tuple going to one destination only with respect to a single target operation. This situation is similar to have the Map results sent to the Reduce nodes. With the underlying streaming platform, the target task ID mapped from the hash partition index on the selected key fields list, “keyList,” over the number of k tasks of the target operation, is calculated by keyList.hashcode( ) % k. Then the actual destination is determined using a network replicated hash table that maps each hash partition index to a physical task, which, however, is out of the scope of the source task.

On the source task, although it is impossible to figure out the physical target task and record the physical mid before emitting a tuple, it is possible to compute the above hash partition index. This allows for the use of the hash partition index as the task alias for identifying the target task. A task alias is denoted by “operationName.a@” such as “gemm.1@,” where “a” is the hash partition index.

Task alias is used for identifying the target task, and virtual mid is used for identifying the output tuple. With a tuple t distributed with fields-grouping, the alias of the target task is t's hash-partition index. A virtual mid is one with the target taskId replaced by the alias. For example, the output tuples of task “tr.9” to tasks “gemm.6” and “gemm.7” are under “fields-grouping” with 2 hash-partitioned index values 0 and 1. These values, 0 and 1, serve as the aliases of the recipient tasks. The target tasks “gemm.6” and “gemm.7” can be represented by aliases “gemm.0@” and “gemm.1@” without ambiguity since, with fields-grouping, the tuples with the same hash-partition index belong to the same group and always go to the same recipient task. Only one task per operation will receive the tuple, and there is no chance for a mid-set to contain more than one virtual-mid with respect to the same target operation.

Although the task alias, “gemm.1@,” is different from the real target tasked, “gemm.6,” it is unique, and all tuples sent to gemm.6 will bear the same target task alias under the given field-grouping. Then an output tuple from, for example, task tr.9 to gemm.6 under “fields-grouping” is identified by the virtual mid tr.9̂gemm.1@-35 where the target taskId gemm.7 is replaced by the task alias “gemm.1@.”

A virtual mid, such as tr.9̂gemm.1@-2, can be composed with a target task alias, and is directly recorded at both source and target tasks and used in both ACK and ASK messages. There is no need to resolve the mapping between a task-alias and the actual task-Id represented by the alias. In case an operation has two or more target operations, such as in the above example where the operation “tr” has 2 target operations, “gemm” and “blast,” an output tuple can be identified by a mid-set containing virtual-mids. For example, an output tuple from task “tr.9” is identified by the mid-set, {tr.9̂blas.0@-30, tr.9̂gemm.1@-35}. This mid-set expresses that the tuple is the 30th tuple sent from “tr.9” to one of the blas tasks, and the 35th to one of the gemm tasks. The recipient task with alias blas.0@, can extract the matched virtual-mid tr.9̂blas.0@-30 based on the match of operation name “blas,” for recording the seq#30 for that virtual channel.

With global-grouping, tuples emitted from a source task are routed to only one task of the recipient operation (i.e., the same instance task of the target operation). The selection of the recipient task is taken by a separate routing component outside of the sender task. A goal of the present systems and methods is for the sender or source task to record the physical messaging channel before a tuple is emitted. For this purpose the present systems and methods do not need to know what the exact task is, but creates a single alias to represent the recipient task. In this case, all tuples go to the same recipient task that is represented by the same alias. The latest seq# is recoded on both the sender and receiving sides. Instead, the present systems and methods consider that all the output tuples belong to the same group that is sent to the same task, and creates a single alias to represent the recipient task.

With direct grouping, a tuple is emitted using an emitDirect application programming interface (API) with the physical tasked, or, more exactly, the task#, as one of its parameters. For channel specific recovery the present systems and methods extend a topology builder to turn the rest of the grouping types not discussed above, to direct grouping. Thus, the present systems and methods modify all other grouping types and map them to direct grouping where for each emitted tuple, the destination task is selected based on load. For example, the destination task that currently has the least load is selected. The channel resolution problem for fields-grouping cannot be handled using emitDirect since the destination is unknown and cannot be generated randomly.

Shuffle grouping is a popular grouping type. As mentioned above it is converted to direct grouping where a tuple is emitted to a designated task selected based on load balancing; namely, the channel with least seq# is selected.

With the above grouping protocol, the present systems and methods track and record the message channels with respect to various grouping types. For “all-grouping” msgId-set is used. For “fields-grouping,” task-alias and virtual-msgId are used. “Direct-grouping” is supported systematically rather than letting a user to decide based on load-balancing; namely, selecting the target task with least load or seq#. Further, the present systems and methods convert all other grouping types, which are random by nature, to the present system-supported direct grouping. The channels with “fields-grouping” cannot be resolved by having it turned to direct-grouping. The combination of mid-set and virtual mid allows for the tracking of the messaging channels of the task with multiple grouping criteria.

For guiding channel resolution, the present systems and methods extract the topology information from the streaming process definition, and build the task specific metadata objects. These task specific metadata objects are task-output-context, “TOC,” and task-input-context, “TIC,” and are used for specifying input and output channels, and grouping types, among other uses.

Multiple TIC and TOC objects are associated with a task. A task, T, has a list of TIC objects; with each specifying the input context of one source task of T. The TIC objects comprise a task ID of source task, Tₛ, that is the key field of TIC. The TIC objects also comprise an operation ID (name) of a source operation, Oₛ, of that T's instance. A grouping type; such as shuffle, field, etc. is also included as a TIC object. The TIC objects also comprise a channel and a stream ID, an abstract dataflow between the source operation, Oₛ, and the operation of this task.

A task, T, has a list of TOC objects as well. Each TOC object specifies the output context of one target operation with a number of target task instances of T. The TOC objects comprise an operation ID (name) of target operation, Oₜ, that is the key field of TOC. The TIC objects also comprise a grouping type; such as shuffle, field, etc. Key indices (int [ ]) indicating the key fields of output tuples for hash partitioning in the field-grouping case are also included as a TOC object. The TOC objects further comprise a channel list comprising the channels from this task to all the tasks of the target operation, Oₜ, and a stream ID, an abstract dataflow between the operation of this task and the target operation Oₜ.

The TIC and TOC objects may be listed as follows:

| [Task Input Context] | |
|---|---|
| public class TaskInputContext { | |
| String | taskID; //key |
| String | componentID; |
| String | grpType; |
| String | channel; |
| String | streamID; |
| [Task Output Context] | |
| public class TaskOutputContext { | |
| String | componentId; //key |
| String | streamId; |
| String | grpType; |
| int[ ] | keyIdxs = null; |
| ArrayList | channels; |

While the TIC list and the TOC list provide static grouping information, the actual input and output <channel, seq#> are recorded in the HashMaps, in ChannelBook, and outChannelBook, of each task. The seq# is the latest or largest sequence number.

With regard to tracking output channels by sender task, a single tuple emitted from a task may go to a number of target tasks. Using TOC, these target messaging channels can be traced operation by operation. The messaging channels and seq#s are represented with either actual or virtual, and either single or set, mids, and stores them in outChannelBook. The system (100) emits only one tuple with the resulting mid or mid-set.

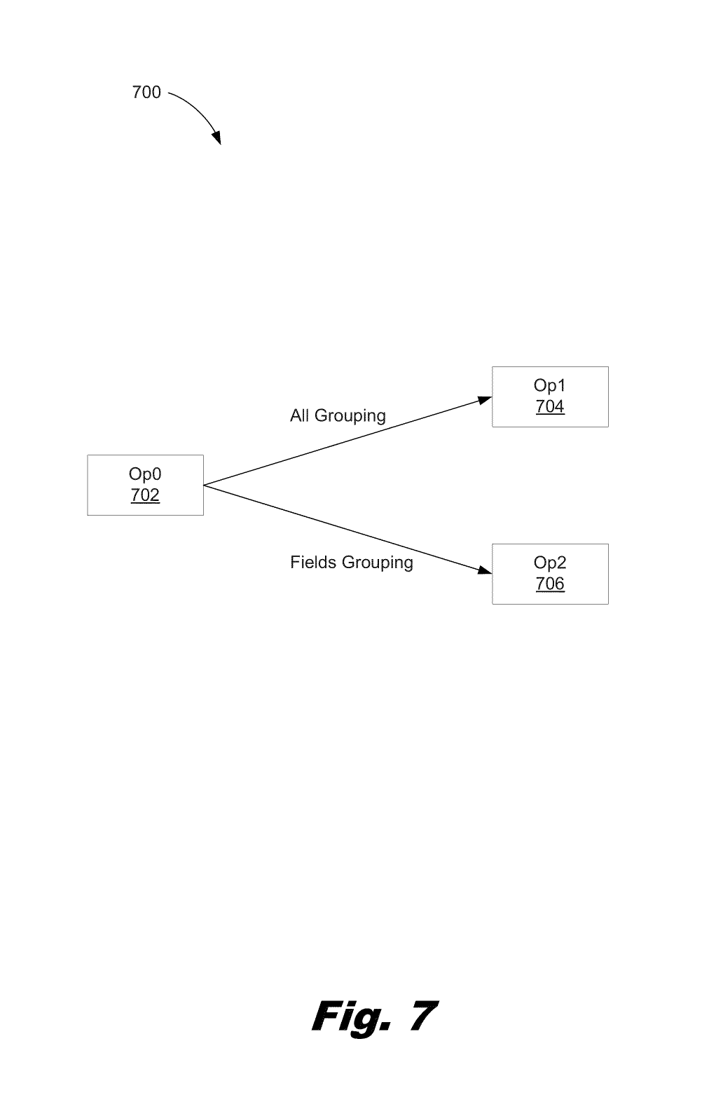

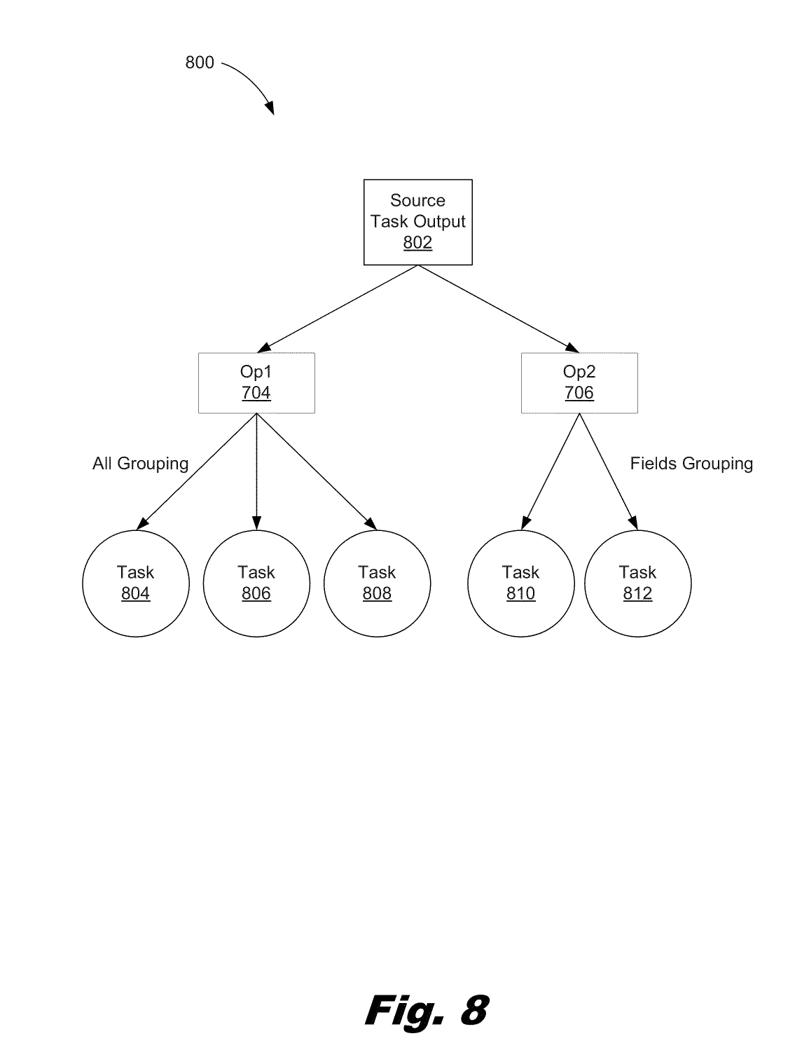

FIG. 7 is a diagram depicting a grouping example (700), according to one example of the principles described herein. FIG. 7 shows an example where operation Op0 (702) has two target operations having 3 tasks and 2 tasks respectively, and with “all-grouping” and “fields-grouping’ respectively. For a task of op0 (702), its TOC, is illustrated in FIG. 8. FIG. 8 is diagram depicting reasoning of output channels using TOC (800) for the grouping example of FIG. 7.

A source task output (802) is provided to Op1 (704) and Op2 (706). Reasoning with this TOC, each output tuple from a task of Op0 (FIG. 7, 702), the source task output context (802), will be distributed to 4 target tasks (804, 806, 808, 812), including three task instances (804, 806, 808) of Op1 (704) using all-grouping and one task (812) of Op2 (706) using field-grouping. Thus, the TOC is identified by a mid-set with four mids, and the one associated with field-grouping is virtual.

When re-sending a tuple upon request through the above-described separate messaging channel (FIG. 6, 610), the task selects the buffered tuple with the tuple's mid matching the requested mid, or the tuple's mid-set containing the requested mid, but resends the tuple with the single, logically matched mid. In other words, in the failure-recovery of a recipient task, the system (100) resolves the tuple based on the requested, single mid and the mid or mid-set contained in the kept tuples, but re-emits the tuple with the single, logically matched mid.

With regard to tracking input channels in a recipient task, when an input tuple is received, its mid or mid-set is extracted and an individual mid (possibly virtual) that logically matches the recipient task is singled out. That single mid is recorded in the in ChannelBook, and used in ACK and ASK messages. During failure-recovery, the recovered task, T, asks each source task to resend the possible next tuple with respect to the latest tuple recorded in T's inputChannelBook. Thus, a mid for the requested tuple is composed. Guided by TIC and the in ChannelBook, a virtual mid where the recovered task is represented by an alias would be created in the fields-grouping case.

The present systems and methods have been built based on architecture and policies explained above. An overview of experimental results using the present systems and methods will now be described. The testing environment included 16 Linux servers with gcc version 4.1.2 20080704 (Red Hat 4.1.2-50), 32G RAM, 400G disk and 8 Quad-Core AMD Opteron Processor 2354 (2200.082 MHz, 512 KB cache). One server holds the coordinator daemon, 15 other servers hold the agent daemons, each agent supervises several worker processes, and each worker process handles a number of task instances. Based on the topology and the parallelism hint of each logical task or operation, a number of instances of that task will be instantiated by the framework to process the data streams.

First, the experiment results were used to verify the correctness of channel tracking based on the stream process topology shown in FIG. 2. For simplicity the spout (FIG. 2, 202) outputs only 100 tuples, delivered to “tr” tasks (204-1, 204-2) in all-grouping, then to “gemm” (206-1, 206-2) and “blas” (208-1, 208-2) tasks in fields-grouping, and then to “ana” (210-1, 210-2) and “agg” (212-1, 212-2) tasks in all-grouping and direct-grouping, respectively. Below are some logged printouts showing the input mid-set, the resolved mid at the corresponding tasks.

### —Task: tr.8

Received mid: {matrix_spout.10̂tr.8-5,matrix_spout.10̂tr.9-5}
Matched mid: matrix_spout.10̂tr.8-5
   —Task: gemm.7
Received mid: {tr.8̂blas.0@-32,tr.8̂gemm.1@-38}
Matched mid: tr.8̂gemm.1@-38
   —Task: blas.4
Received mid: {tr.8̂blas.0@-12,tr.8̂gemm.0@-11}
Matched mid: tr.8̂blas.0@-12

### —Task: ana.11

Received mid: {gemm.6̂ana.11-85,gemm.6̂ana.12-85}
Matched mid: gemm.6̂ana.11-85

### —Task: agg.2

Received mid: blas.4̂agg.2-40
Matched mid: blas.4̂agg.2-40

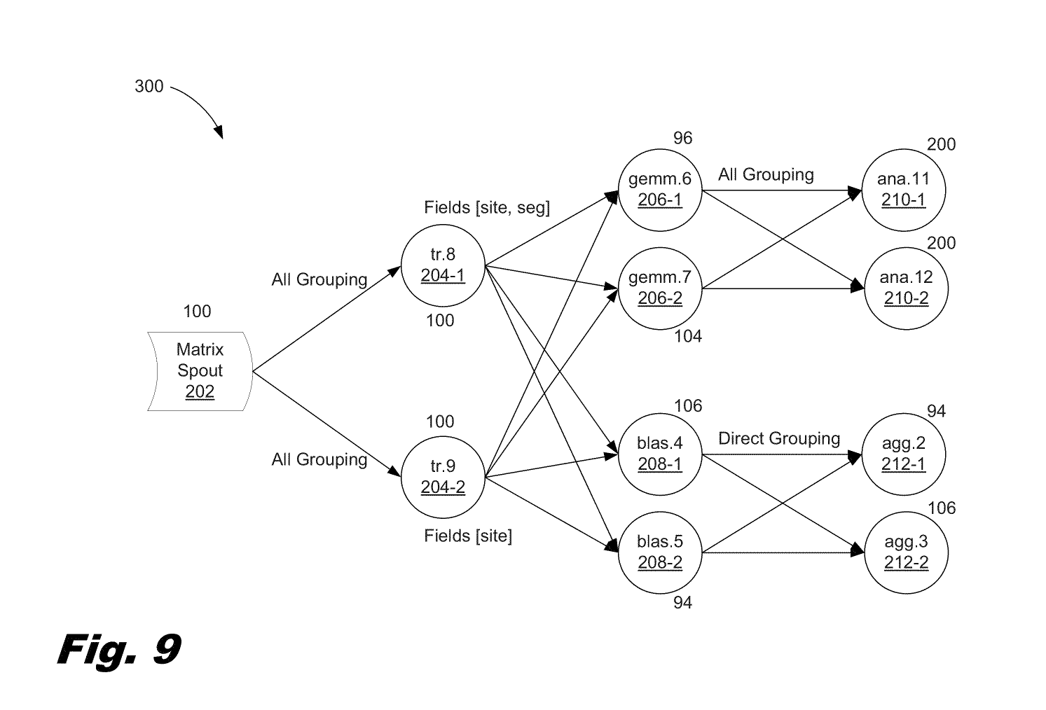

FIG. 9 is a diagram of an experimental result of the physical streaming process with each operation having multiple instances of FIG. 3, according to one example of the principles described herein. Some logged information on the results of the experiment will now follow. After processing 100 initial input tuples produced by the matrix-spout, the final states of the tasks, including the number of checkpointed tuples (the last ckSeq) as well as the content of InChannelBook and the OutChannelBook, are listed below, and the number of tuples processed by each task is illustrated in FIG. 9. These numbers and states are consistent with the defined semantics of steam processing with the specified grouping criteria.

For example, with all-grouping, tasks tr.8 (204-1) and tr.9 (204-2) each get 100 input tuples from the matrix-spout (202). Then the 100 tuples output from tr.8 (204-1) and the 100 tuples output from tr.9 (204-2) are distributed to tasks gemm.6 (206-1) and gemm.7 (206-2) with each receiving 96 and 104 tuples, respectively, making a total of 200 tuples. Then with all-grouping, each of the derived tuples is further delivered to both tasks ana.11 (210-1) and ana.12 (210-2). Therefore, tasks ana.11 (210-1) and ana.12 (210-2) each received 200 tuples.

++FINAL tr.8:ckSeq=100
++FINAL tr.8:InChannelBook={matrix_spout.10̂tr.8=100}
++FINAL tr.8:OutChannelBook={tr.8̂blas.1@=47, tr.8̂blas.0@=53, tr.8̂gemm.1@=52, tr.8̂gemm.0@=48}
++FINAL tr.9:ckSeq=100
++FINAL tr.9:InChannelBook={matrix_spout.10̂tr.9=100}
++FINAL tr.9:OutChannelBook={tr.9̂blas.1@=47, tr.9̂blas.0@=53, tr.9̂gemm.0@=48, tr.9̂gemm.1@=52}
++FINAL blas.4:ckSeq=106
++FINAL blas.4:InChannelBook={tr.9̂blas.0@=53, tr.8̂blas.0@=53}
++FINAL blas.4:OutChannelBook={blas.4̂agg.3=53, blas.4̂agg.2=53}
++FINAL blas.5:ckSeq=94
++FINAL blas.5:InChannelBook={tr.9̂blas.1@=47, tr.8̂blas.1@=47}
++FINAL blas.5:OutChannelBook={blas.5̂agg.3=53, blas.5̂agg.2=41}
++FINAL gemm.6:ckSeq=96
++FINAL gemm.6:InChannelBook={tr.9̂gemm.0@=48, tr.8̂gemm.0@=48}
++FINAL gemm.6:OutChannelBook={gemm.6̂ana.11=96, gemm.6̂ana.12=96}
++FINAL gemm.7:ckSeq=104
++FINAL gemm.7:InChannelBook={tr.8̂gemm.1@=52, tr.9̂gemm.1@=52}
++FINAL gemm.7:OutChannelBook={gemm.7̂ana.12=104, gemm.7̂ana.11=104}
++FINAL ana.11:ckSeq=200
++FINAL ana.11:InChannelBook={gemm.7̂ana.11=104, gemm.6̂ana.11=96}

### ++FINAL ana.11:OutChannelBook={ }

++FINAL ana.12:ckSeq=200
++FINAL ana.12:InChannelBook={gemm.7̂ana.12=104, gemm.6̂ana.12=96}

### ++FINAL ana.12:OutChannelBook={ }

++FINAL agg.2:ckSeq=94
++FINAL agg.2:InChannelBook={blas.5̂agg.2=41, blas.4̂agg.2=53}

### ++FINAL agg.2:OutChannelBook={ }

++FINAL agg.3:ckSeq=106
++FINAL agg.3:InChannelBook={blas.5̂agg.3=53, blas.4̂agg.3=53}

### ++FINAL agg.3:OutChannelBook={ }

In the streaming process example shown in FIG. 2, the heaviest computation is conducted by tasks of operations gemm (206) and blas (208). These two operations are similar, so, for the sake of brevity, gemm (206) will be the focus of the following discussion. As indicated above, “gemm: is the abbreviation for “general matrix multiply,” a subroutine in the basic linear algebra subprograms (BLAS). Gemm calculates the new value of matrix C based on the matrix-product of matrices A and B, and the old value of matrix C, as:

C=alpha*AB+beta*C Eq. 1

where alpha and beta values are scalar coefficients. GEMM is often tuned by high performance computing (HPC) vendors to run as fast as possible, because it is the building block for so many other routines. It is also the most important routine in the LINPACK benchmark. For this reason, implementations of fast BLAS library focus on GEMM performance first.

The purpose of the above experiment is to examine the impact of checkpoint to the performance of the streaming process involving GEMM operations. For this reason the performance ratio with and without checkpointing of a single task is examined. Since multiple tasks may have overlapping disk-writing in checkpointing, measuring their overall performance would not provide a clear picture of the above ratio.

Of particular interest is the turning point on the size of input matrices where checkpointing has significant impact to the performance before it, and insignificant impact after it. As in the tuple by tuple stream processing, the overall latency is nearly proportional to the number of input tuples, and the performance ratio with and without checkpointing is measured, the impact of the number of input tuples, say from 1K to 1M, not being significant.

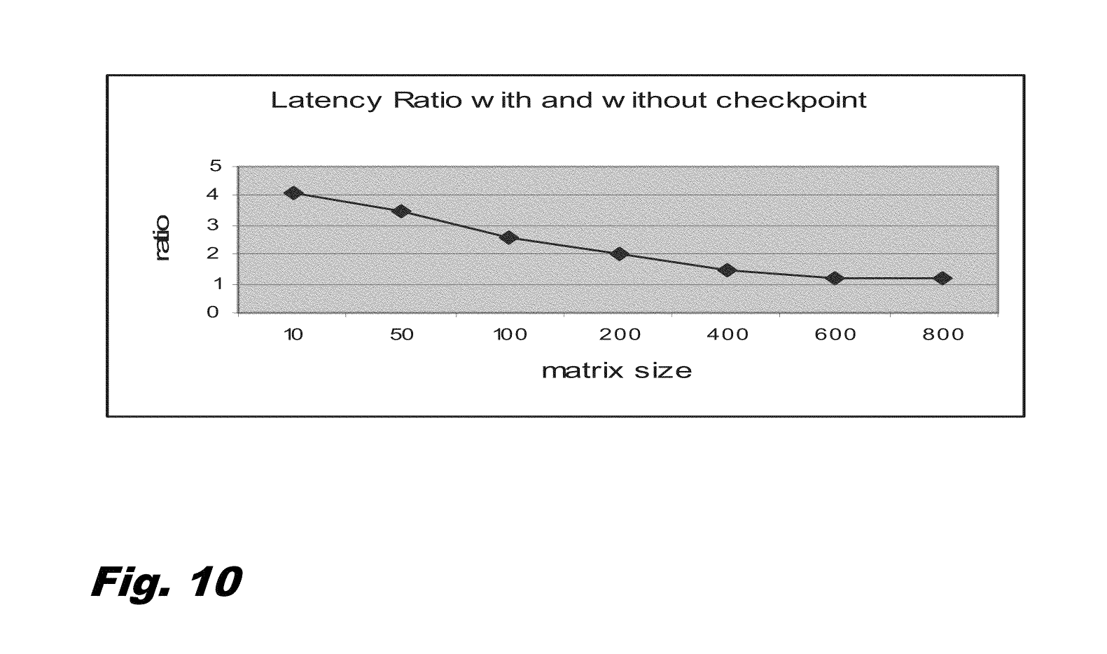

Each original input tuple has three two-dimensional N×N matrices of float values, and the above ratio with respect to N is measured. FIG. 10 is a diagram depicting the latency ratio with and without checkpoint, according to one example of the principles described herein. The results shown in FIG. 10 indicate that when the matrix dimension size N is smaller than 600, checkpointing has a visible impact to the latency of the streaming process. After the matrix dimension size N passes 600, that impact becomes insignificant since the latency is dominated by the computation complexity.

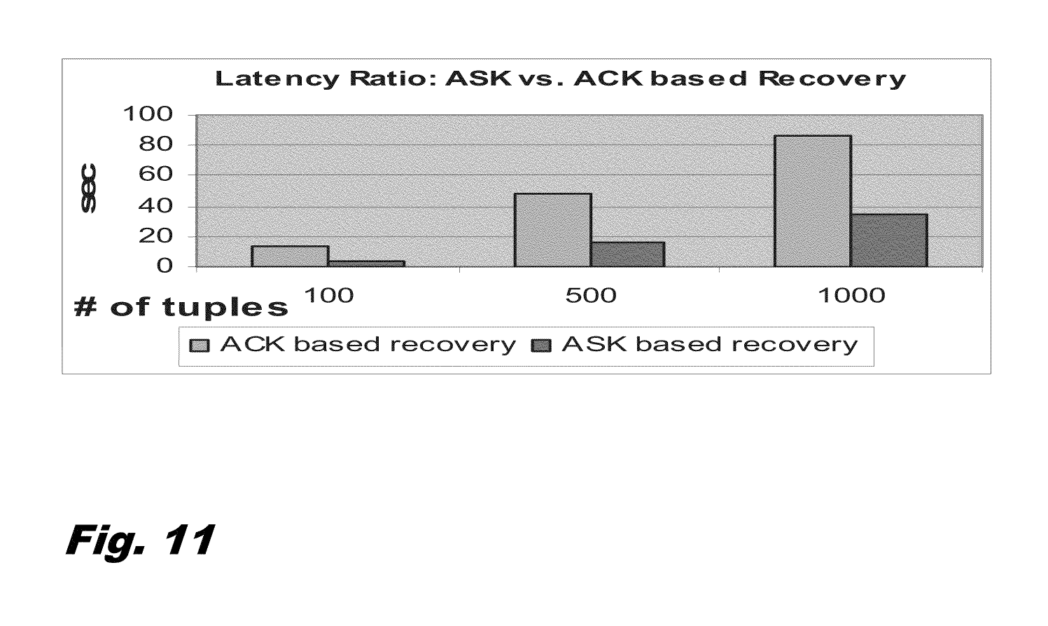

Comparing the performance of the ASK-based transactional stream processing with the ACK based transactional stream processing, is another motivation of these experiments. FIG. 11 is a diagram depicting a performance comparison between ACK based and ASK based recovery protocols, according to one example of the principles described herein. In testing, the failure rate is set to 1%. The matrix dimension size is fixed to 20. With the ACK based approach, a task does not move on to process the next tuple until the result of processing the current tuple has been received, processed, and acknowledged by all target tasks. Otherwise, the tuple will be re-sent after timeout. Therefore, a latency overhead is incurred during processing each tuple. Under the present ASK based approach, a task does not wait for the acknowledgement to move forward since the acknowledgement is handled asynchronously to the task execution. The latency overhead is only incurred during failure recovery, which is rare. Therefore, the ASK based approach can significantly improve the overall performance. Comparison results as shown in FIG. 11 verify this observation.

The present disclosure presents transactional stream processing with the task-oriented, fine-grinned and backtrack-based failure recovery mechanisms. To provide these mechanisms on top of an existing stream processing platform where message routing is handled by separate system components inaccessible to individual tasks, the present disclosure describes enablement of tasks to track physical messaging channels logically in order to realize re-messaging during failure recovery. Thus, the notions of virtual channel, task alias and messageId-set were introduced and described. The present disclosure also describes providing a designated messaging channel, separated from the regular dataflow channel, for signaling ACK/ASK messages and for resending tuples in order to avoid interrupting the regular order of data transfer.

The present open station architecture ensures all the transactional properties are system supported and transparent to users. Virtual channel mechanisms allow the present systems and methods to handle failure recovery correctly in elastic streaming processes, and the ASK-based recovery mechanism significantly outperforms the ACK-based one. The proposed systems and methods may be integrated into a Live BI platform, a component of Hewlett-Packard's Igniting Information Insight strategy with a number of target businesses, which supports the reliable delivery of quality insights and predictive analytics over Big, Fast, Total (BFT) data.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the data processing system (100) or other programmable data processing apparatus, implement the functions or acts specified in the flowchart and/or block diagram block or blocks. In one example, the computer usable program code may be embodied within a computer readable storage medium; the computer readable storage medium being part of the computer program product.

The specification and figures describe a method of recovering a failure in a data processing system comprising, with a processor, recording a number of input channels and sequence numbers for a number of input tuples transferred via a first messaging channel to a recipient task. The method further comprises recording a number of output channels and sequence numbers for a number of output tuples, and if a failure occurs, resolving the input and output channels. A system for processing data comprises a processor, and a memory communicatively coupled to the processor, in which the processor, executing computer usable program code records a number of input channels and sequence numbers for a number of input tuples transferred to a recipient task. The system further derives a number of output tuples by processing input tuples, records a number of output channels and sequence numbers for the output tuples, and checkpoints a number of states and a number of output messages, emits the output tuples to a target node, and if a failure occurs, resolves the input and output channels. These methods and systems for recovering a failure in a data processing system may have a number of advantages, including: (1) providing for continuous emission of output tuples with checkpointing while requesting a source task to resend missing tuples only when the system is recovered from a failure; (2) resolves input and output channels so that, and (3) provides a designated messaging channel, separated from the regular dataflow channel, for signaling ACK/ASK messages and resending tuples, to avoid the interruption of the regular order of tuple delivery, among other advantages.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method of recovering a failure in a data processing system comprising, with a processor:
recording a number of input channels and sequence numbers for a number of input tuples transferred via a first messaging channel to a recipient task;
recording a number of output channels and sequence numbers for a number of output tuples; and
if a failure occurs, resolving the input and output channels.

2. The method of claim 1, in which resolving the input and output channels comprises recovering the task, comprising:
recovering the recipient task's computation results; and
recovering the recipient task's backward chaining for resolving missing input based on the input channels and sequence numbers recorded.

3. The method of claim 2, further comprising recovering the recipient task's forward chaining for redelivering the recipient task's output based on the output channels and sequence numbers recorded.

4. The method of claim 1, in which recording the number of input channels and sequence numbers for the number of input tuples transferred via the first messaging channel to the recipient task, and recording the number of output channels and sequence numbers for the number of output tuples is performed before the recipient task emits the output tuples.

5. The method of claim 1, in which processing of tasks is performed without waiting for acknowledgement signals.

6. The method of claim 1, in which acknowledgement signals are sent asynchronously with respect to task execution.

7. The method of claim 1, in which buffered output tuples sent from a source task are deleted after the output tuples are successfully processed by a number of target tasks.

8. The method of claim 1, further comprising designating a second messaging channel separate from the first messaging channel, in which the second messaging channel is used for message transfer during failure recovery.

9. The method of claim 1, further comprising:
checkpointing the states and a number of output messages; and
emitting the output tasks to a number of target tasks.

10. The method of claim 1, in which the input tuples and output tuples are communicated through messaging.

11. A system for processing data, comprising:
a processor; and
a memory communicatively coupled to the processor, the processor to:
record a number of input channels and sequence numbers for a number of input tuples transferred to a recipient task;
derive a number of output tuples by processing input tuples;
record a number of output channels and sequence numbers for the output tuples;
checkpoint a number of states and a number of output messages;
emit the output tuples to a target node; and
if a failure occurs, resolve the input and output channels.

12. The system of claim 11, in which the system is provided as a service over a network.

13. A computer program product for recovering a failure in a data processing system, the computer program product comprising:
a computer readable storage medium comprising computer usable program code embodied therewith, the computer usable program code comprising:
computer usable program code to, when executed by a processor, record a number of input channels and sequence numbers for a number of input tuples transferred via a first messaging channel to a recipient task before the recipient task emits output tuples;
computer usable program code to, when executed by the processor, record a number of output channels and sequence numbers for a number of output tuples before the recipient task emits output tuples; and
computer usable program code to, when executed by the processor, if a failure occurs, resolving the input and output channels.

14. The computer program product of claim 13, further comprising computer usable program code to, when executed by the processor, delete buffered output tuples sent from a source task after the output tuples are successfully processed by a number of target tasks.

15. The computer program product of claim 13, further comprising computer usable program code to, when executed by the processor, sending messages pertaining to failure recovery via a second messaging channel.
